(19) United States
(12) Patent Application Publication
(10) Pub. No.: US 2012/0212809 A1
(43) Pub. Date: Aug. 23, 2012

(54) Infrared Cut Filter

(75) Inventors: Yi-Sheng Chang, Taichung (TW); Te-Wei Liu, Taichung (TW)

(73) Assignee: ASIA OPTICAL CO., INC., Taichung (TW)

(21) Appl. No.: 13/101,557

(22) Filed: May 5, 2011

(30) Foreign Application Priority Data
Feb. 23, 2011 (TW) 100105949

(51) Int. Cl. G02B 5/28

(52) U.S. Cl. 359/359

(57) ABSTRACT

An embodiment of the invention provides an infrared cut filter including a light transmissive substrate, a first stack of infrared cut films and a second stack of infrared cut films. The light transmissive substrate has a first surface and a second surface opposite thereto. The first stack of infrared cut films is disposed on the first surface, and has a plurality of first films and a plurality of second films stacked alternately, wherein each of the first films has a lower refractive index than each of the second films. The second stack of infrared cut films is disposed on the second surface, and has a plurality of third films and a plurality of fourth films stacked alternately, wherein each of the third films has a lower refractive index than each of the fourth films.

### CROSS REFERENCE TO RELATED APPLICATIONS

This Application claims priority of Taiwan Patent Application No. 100105949, filed on Feb. 23, 2011, the entirety of which is incorporated by reference herein.

### BACKGROUND OF THE INVENTION

1. Field of the Invention

The present invention relates to an optical device, and in particular relates to an infrared cut filter.

2. Description of the Related Art

Recently, various digital image capturing devices (e.g. digital cameras or digital video cameras) have been used in various applications and have gradually substituted conventional film cameras. The digital image capturing device has a charge-coupled device (CCD) or a complementary metal oxide semiconductor (CMOS) image sensor as a photosensitive element to transfer an image of an object to an electronic signal. However, the CCD (or the CMOS image sensor) has a far wider photosensitive range than human eyes. For example, the CCD (or the CMOS image sensor) can sense infrared light that human eyes can't see. Therefore, if an incident light in the infrared region is not shaded properly, colors of the image captured by the digital image capturing device is different from colors of the object seen by human eyes, such that the digital image capturing device can't accurately capture the image of the object.

Therefore, commercially available digital image capturing devices have infrared cut filters disposed on the front of a photosensitive element to shade the incident light in the infrared region, such that the photosensitive element can merely sense the incident light in the visible region. As such, the colors of the image captured by the digital image capturing device are close to the colors of the object which is seen by human eyes. The conventional manufacturing method of an infrared cut filter forms an infrared cut layer and an anti-reflection layer on opposite surfaces of a substrate, respectively.

FIG. 1 shows a relation curve of various wavelengths of light transmitting through a conventional infrared cut filter and corresponding transmittances. Referring to FIG. 1, the conventional infrared cut filter can't shade the light in the near infrared region (e.g. wavelength ranging from 900 nm to 1100 nm) completely because of the alternate stacking of the films. Therefore, a transmittance of the light transmitting through the infrared cut film is larger than 1% (as shown in the dotted line frame of the FIG. 1), which results in a distortion (or a color change) of the image captured by the digital image capturing device.

### BRIEF SUMMARY OF THE INVENTION

An embodiment of the invention provides an infrared cut filter, comprising: a light transmissive substrate having a first surface and a second surface opposite thereto; a first stack of infrared cut films disposed on the first surface and having a plurality of first films and a plurality of second films stacked alternately, wherein each of the first films has a lower refractive index than each of the second films; and a second stack of infrared cut films disposed on the second surface and having a plurality of third films and a plurality of fourth films stacked alternately, wherein each of the third films has a lower refractive index than each of the fourth films.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a relation curve of various wavelengths of light transmitting through a conventional infrared cut filter and corresponding transmittances.

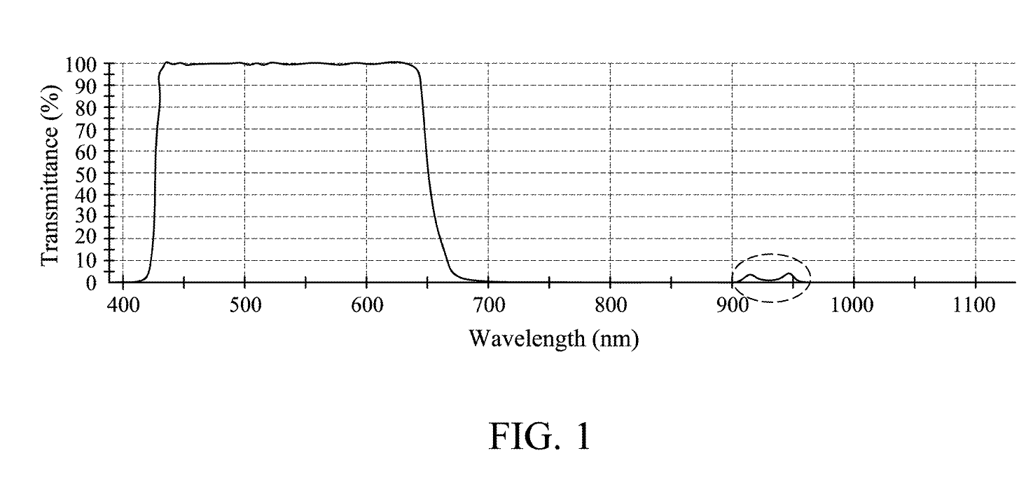

FIG. 2 is a cross-sectional view showing an infrared cut filter in accordance with an embodiment of the present invention; and

FIG. 3 shows a relation curve of various wavelengths of light transmitting through an infrared cut filter in accordance with an embodiment of the present invention and corresponding transmittances.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It is understood, that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numbers and/or letters in the various examples. This repetition is for the purpose of simplicity and clarity and does not in itself dictate a relationship between the various embodiments and/or configurations discussed. Furthermore, descriptions of a first layer “on,” “overlying,” (and like descriptions) a second layer, include embodiments where the first and second layers are in direct contact and those where one or more layers are interposing the first and second layers.

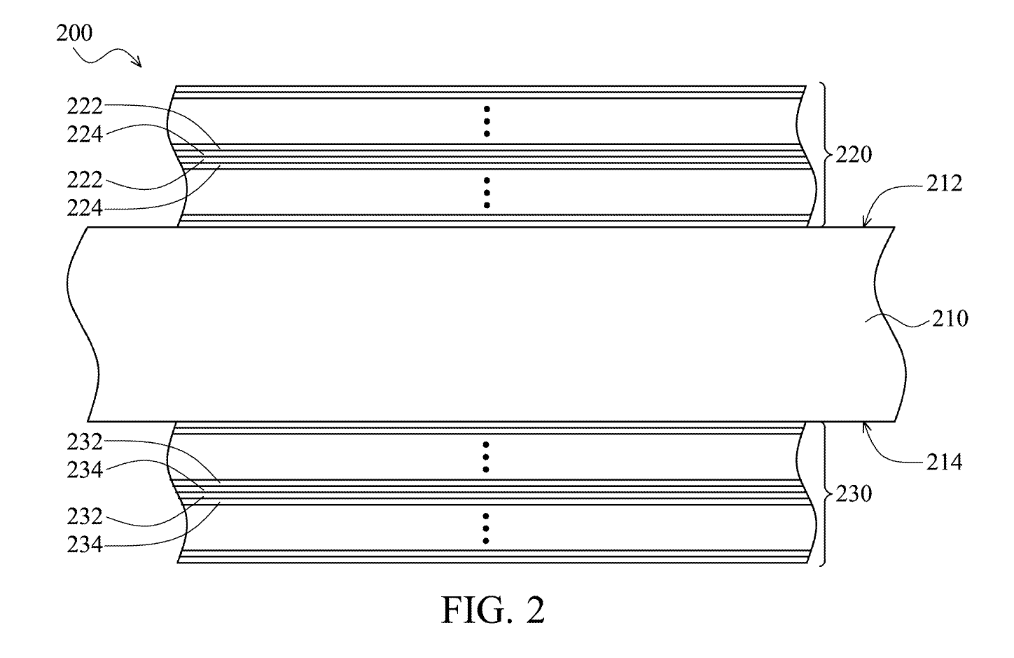

FIG. 2 is a cross-sectional view showing an infrared cut filter in accordance with an embodiment of the present invention. Referring to FIG. 2, an infrared cut filter 200 includes a light transmissive substrate 210, a first stack 220 of infrared cut films and a second stack 230 of infrared cut films. The light transmissive substrate 210 has a first surface 212 and a second surface 214 opposite thereto. The first stack 220 of infrared cut films is disposed on the first surface 212 and has a plurality of first films 222 and a plurality of second films 224 stacked alternately, wherein the first film 222 has a lower refractive index than the second film 224. In the present embodiment, the first film 222 has a smaller optical thickness than the second film 224.

The second stack 230 of infrared cut films is disposed on the second surface 214 and has a plurality of third films 232 and a plurality of fourth films 234 stacked alternately, wherein each of the third films 232 has a lower refractive index than each of the fourth films 234. In the present embodiment, the third film 232 has a smaller optical thickness than the fourth film 234. Environmental light may be sequentially transmitted through the first stack 220 of infrared cut films, the light transmissive substrate 210 and the second stack 230 of infrared cut films.

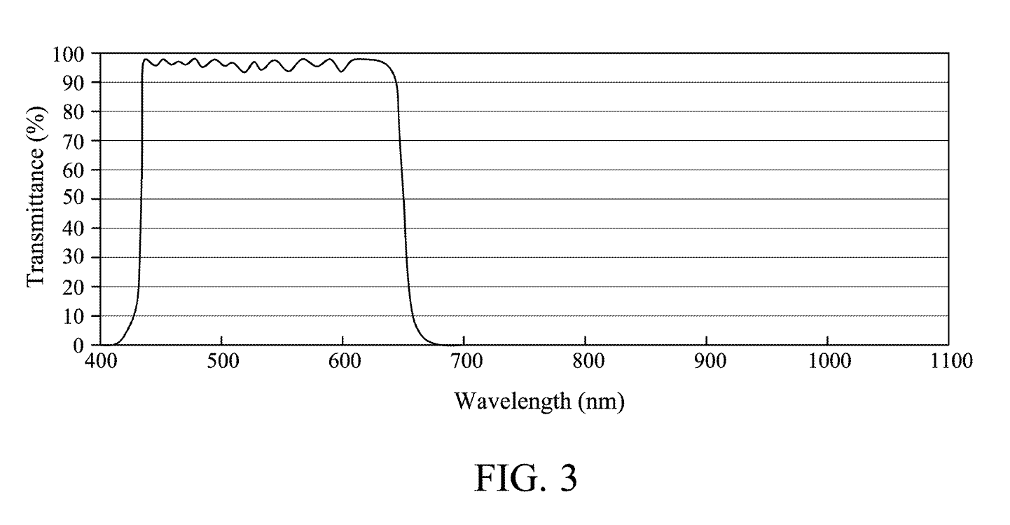

FIG. 3 shows a relation curve of various wavelengths of light transmitting through an infrared cut filter in accordance with an embodiment of the present invention and corresponding transmittances. It should be noted that, in the present embodiment, the first and the second stacks 220 and 230 of infrared cut films are formed on the first surface 212 and the second surface 214 of the light transmissive substrate 210, respectively, and therefore an incident light may be affected by a synergistic effect between the first and the second stacks 220 and 230 of infrared cut films when being transmitted through the infrared cut filter 200. As a result, a transmittance of the incident light in the near infrared region (e.g. wavelength ranging from 900 nm to 1100 nm) may be lower than 0.001% (as shown in FIG. 3), thereby alleviating (or hindering) IR leakage of a conventional infrared cut filter.

In one embodiment, the first film 222 and the third film 232 have refractive indices in the range of between 1.38 and 1.44. The second film 224 and the fourth film 234 have refractive indices in the range of between 2.1 and 2.7, for example. In other words, the first film 222 and the third film 232 are low-refractive-index films, and the second film 224 and the fourth film 234 are high-refractive-index films.

The first film 222 and the third film 232 include silicon oxide (e.g. silicon dioxide) or other suitable low-refractive-index materials, for example. The second film 224 and the fourth film 234 include tantalum oxide, titanium dioxide, or other suitable high-refractive-index materials, for example. The first film 222, the second film 224, the third film 232 and the fourth film 234 are formed by evaporation or sputtering, for example. The light transmissive substrate 210 includes glass, a transparent polymer material or other suitable transparent materials, for example. The light transmissive substrate 210 has a thickness ranging from 0.1 mm to 0.3 mm, for example.

In one embodiment, the first stack 220 of infrared cut films and the second stack 230 of infrared cut films may directly contact the light transmissive substrate 210. In one embodiment, the first stack 220 of infrared cut films is disposed directly on the second stack 230 of infrared cut films.

In one embodiment, a number of the infrared cut films included in the first stack 220 (or the second stack 230) may range from 40 to 60, i.e. a sum of numbers of the high-refractive-index films and the low-refractive-index films of the first stack 220 (or the second stack 230). Also, the number of the infrared cut films included in the first stack 220 may be equal or not equal to the number of the infrared cut films included in the second stack 230, depending on application needs.

Each of the first films 222, the second films 224, the third films 232, and the fourth films 234 may have the same optical thickness of λ₀/4, wherein λ₀ represents a center wavelength (560 nm herein).

In view of the foregoing, in the present invention, two stacks of infrared cut films are formed on an upper surface and a lower surface of the light transmissive substrate, respectively, and therefore an incident light may be affected by a synergistic effect between the two stacks of infrared cut films when being transmitted through the infrared cut filter to reduce a transmittance of the incident light in the near infrared region, thereby alleviating (or hindering) IR leakage of a conventional infrared cut filter.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An infrared cut filter, comprising:
a light transmissive substrate having a first surface and a second surface opposite thereto;
a first stack of infrared cut films disposed on the first surface and having a plurality of first films and a plurality of second films stacked alternately, wherein each of the first films has a lower refractive index than each of the second films; and
a second stack of infrared cut films disposed on the second surface and having a plurality of third films and a plurality of fourth films stacked alternately, wherein each of the third films has a lower refractive index than each of the fourth films.

2. The infrared cut filter as claimed in claim 1, wherein each of the first films and each of the third films have refractive indices in the range of between 1.38 and 1.44.

3. The infrared cut filter as claimed in claim 1, wherein each of the second films and each of the fourth films have refractive indices in the range of between 2.1 and 2.7.

4. The infrared cut filter as claimed in claim 1, wherein each of the first films and each of the third films comprise silicon oxide.

5. The infrared cut filter as claimed in claim 1, wherein each of the second films and each of the fourth films comprise tantalum oxide.

6. The infrared cut filter as claimed in claim 1, wherein the light transmissive substrate comprises glass or a transparent polymer material.

7. The infrared cut filter as claimed in claim 1, wherein the first stack of infrared cut films and the second stack of infrared cut films directly contact the light transmissive substrate.

8. The infrared cut filter as claimed in claim 1, wherein the first stack of infrared cut films is disposed directly on the second stack of infrared cut films.

9. The infrared cut filter as claimed in claim 1, wherein the optical thickness of the first film is smaller than the second film, and the optical thickness of the third film is smaller than the fourth film.
